(19) United States
(12) Patent Application Publication
(10) Pub. No.: US 2025/0215272 A1
(43) Pub. Date: Jul. 3, 2025

(54) Moisture Curable Adhesive Compositions

(71) Applicant: Kaneka Americas Holding, Inc., Pasadena, TX (US)

(72) Inventors: Jonathan Barrus, Pasadena, TX (US); Ruolei Wang, Pasadena, TX (US); Yoshiteru Masaoka, Pasadena, TX (US)

(73) Assignee: Kaneka Americas Holding, Inc., Pasadena, TX (US)

(21) Appl. No.: 18/852,706

(22) PCT Filed: Mar. 28, 2023
(86) PCT No.: PCT/US2023/016543

§ 371 Date: Sep. 30, 2024

Related U.S. Application Data
(60) Provisional application No. 63/325,340, filed on Mar. 30, 2022.

(51) Int. Cl. C09J 7/32; C09J 7/24

(52) U.S. Cl. CPC C09J 7/32; C09J 7/241

(57) ABSTRACT

A curable composition, a method of applying the same, and a composition including the same are disclosed herein. In some embodiments, a curable composition includes a component (A) having an organic polymer containing reactive silicon groups; a component (B) having a chlorinated polyolefin polymer; a component (C) having a silane compound having a dimethoxysilyl moiety; and a component (D) having a silane compound having a trimethoxysilyl moiety.

### CROSS-REFERENCE TO RELATED APPLICATION

The present application claims the benefit of the filing date of U.S. Provisional Application No. 63/325,340, filed on Mar. 30, 2022, entitled “Moisture Curable Adhesive Compositions,” the disclosure of which is hereby incorporated herein by reference.

### FIELD OF THE INVENTION

The present invention relates to a moisture curable adhesive composition that includes an organic polymer containing reactive silicon groups. The invention relates in particular to a moisture curable adhesive composition having full strength adhesion and utility strength adhesion to an adhesion-resistant substrate, such as thermoplastic polyolefin (TPO) and the like, within desired time periods.

### BACKGROUND OF THE INVENTION

In recent years, investigations have been made for improving the adhesiveness to an adhesion-resistant substrate, such as ethylene propylene diene rubber (EPDM), by the addition of a thermoplastic elastomer to a reactive silicon group-containing organic polymer (for example, Japanese Patent No. 4485246B2 to Kanegafuchi Chemical Industry Co., Ltd. and Kaneka Texas Corp.).

U.S. Pat. No. 7,759,425 to Kaneka Corp. describes a moisture curable formulation to improve adhesion to TPO through incorporation of a tackifier and chlorinated polyolefin to reactive silicon group-containing organic polymers.

U.S. Pat. No. 7,767,308 to Chemlink, Inc. describes the use of reactive silicon group-containing organic polymers, phenolic tackifiers, and silane adhesion promoters for bonding with rubber material.

WO2020/176861 describes moisture curable compositions for universal good adhesion across different substrates, including EPDM, polyvinyl chloride (PVC), and TPO.

Of these substrates, TPO is generally regarded as the most difficult low surface energy substrate for which to achieve good adhesion, such that if adhesion to TPO is achieved, EPDM and PVC adhesion generally follow. Achieving adhesion to the smooth-backed version of these substrates is particularly difficult in comparison to their fleece-backed versions, which contain an additional surface treatment to improve adhesion.

Another issue with adhesive compositions is the time needed for curing for full strength adhesion or for utility strength adhesion. For example, curing can take up to several weeks to obtain full strength adhesion. However, for certain applications, such as roofing installation, the roofing could be removed by a catastrophic event, such as an unforeseen wind event, during the time it takes for utility strength adhesion or full strength adhesion to be realized.

There is a need to develop an adhesive formulation that achieves utility strength adhesion and/or full strength adhesion in shorter time periods.

### BRIEF SUMMARY OF THE INVENTION

A curable composition, a method of applying the same, and a composition including the same are disclosed herein. In some embodiments, a curable composition includes a component (A) having an organic polymer containing reactive silicon groups; a component (B) having a chlorinated polyolefin polymer; a component (C) having a silane compound having a dimethoxysilyl moiety; and a component (D) having a silane compound having a trimethoxysilyl moiety.

In some embodiments, a method of applying a curable composition includes applying the curable composition to a substrate.

In some embodiments, a composition includes a substrate; and the curable composition.

### DETAILED DESCRIPTION

An object of the present invention is to provide a moisture curable adhesive composition that provides excellent adhesion on any surface, including adhesion-resistant surfaces, such as EPDM, PVC, and TPO, on either smooth-backed or fleece-backed variants of these substrates, where utility strength and full strength adhesion is achieved over desired time periods, such as about 24 hours or less, or more preferably 4 hours or less.

Generally, to achieve the desired adhesion strength in the desired time period, a moisture curable adhesive composition includes the following components: component (A) having an organic polymer having reactive silicon groups, component (B) having a chlorinated polyolefin polymer (CPO), component (C) having a silane compound having a dimethoxysilyl (DMS) moiety, and component (D) having a silane compound having a trimethoxysilyl (TMS) moiety. The latter three components (B) to (D) can be utilized as adhesion promoters in the moisture curable composition.

Though not wanting to be bound by any particular theory, incorporating TMS moieties as an adhesion promoter can improve the rate of curing in an adhesive composition. However, using TMS moieties exclusively as an adhesion promoter can result in increased modulus of the cured composition and poor adhesion to the substrate. By offsetting TMS moieties with the addition of DMS moieties as an additional adhesion promoter, the threshold modulus can be maintained in the cured composition to achieve good adhesion to the substrate.

Further, by using DMS moieties, the amino functionality is retained in the adhesion promoter, which works well in combination with CPO to promote adhesion on low energy surfaces, such as TPO.

Further still, by retaining some portion of TMS moieties, the moisture scavenging effect is preserved, which promotes better viscosity stability and therefore enhanced storage stability, of critical importance for ease of application via preferred methods of trowel, squeegee, roller, or sprayer.

A moisture curable adhesive composition including components (A) to (D) can achieve excellent adhesion to smooth-backed surfaces, such as TPO, in about 24 hours or less, using various large-scale implementation methods, such as trowel, squeegee, roller or sprayer, which are necessary for commercial applications. Moreover, it is found that the moisture curable adhesive composition including components (A) to (D) surprisingly achieves utility adhesion within about 4 hours. For example, by achieving utility adhesion within this time frame, an installer can check their work at the end of the work day to ensure sufficient adhesion has been developed and forgo inefficient precautionary measures such as temporary ballasting.

### Substrates

Exemplary EPDM substrates can include Carlisle Sure-Seal® EPDM, Carlisle Sure-White® EPDM, Johns Manville EPDM NR/R, Firestone RubberGard™ EPDM, Firestone Ecowhite™ EPDM, and/or Firestone Fullforce™ EPDM. Exemplary PVC substrates can include GAF EverGuard® PVC, GAF EverGuard® PVC XK, Carlisle Sure-Flex® PVC, Carlisle Sure-Flex® KEE HP, Johns Manville PVC SD Plus, Johns Manville PVC with KEE, and/or Sika Sarnafil PVC. Exemplary TPO substrates can include Firestone UltraPly™ TPO, Firestone UltraPly™ TPO XR, Firestone UltraPly™ TPO Flex Adhered, Firestone Platinum TPO, GAF EverGuard® TPO, GAF EverGuard Extreme® TPO, GAF EverGuard® TPO Ultra, and/or Carlisle Sure-Weld TPO.

### Component (A)

A moisture curable composition includes a component (A) comprising an organic polymer containing reactive silicon groups represented by the following general formula (1):

—Si(R¹₃₋ₐ)Xₐ (1)
wherein R¹ represents an alkyl group having 1 to 20 carbon atoms, an aryl group having 6 to 20 carbon atoms, or an aralkyl group having 7 to 20 carbon atoms; X represents a hydrolyzable group; and a is an integer from 1 to 3; provided that when a is 1 each R¹ may be the same or different; and provided that when a is 2 or 3, each X may be the same or different.

In some embodiments, X represents-OR, wherein R is an alkyl group having 1 to 2 carbon atoms.

When X in general formula (1) is a hydrolyzable group, X is not particularly limited as long as X is a known hydrolyzable group. Specific examples thereof include hydrogen and halogen atoms; and alkoxy, acyloxy, ketoximate, amino, amide, acid amide, aminooxy, mercapto, and alkenyloxy groups. Out of these, alkoxy groups such as methoxy, ethoxy, propoxy, and isopropoxy groups are in particular preferred, since the hydrolyzability thereof is mild, allowing the compound to be easily handled.

R¹ in general formula (1) is not particularly limited and may be an alkyl group having 1 to 20 carbon atoms, an aryl group having 6 to 20 carbon atoms, or an aralkyl group having 7 to 20 carbon atoms. Specific examples thereof include alkyl groups such as methyl, ethyl, propyl, and isopropyl groups; aryl groups such as a phenyl group; and aralkyl groups such as a benzyl group. Out of these groups, a methyl group is particularly preferred from the viewpoint of the availability of the starting material.

A specific structure of the reactive silicon group represented by general formula (1) is not particularly limited, as long as the structure is known. Particularly preferred are trimethoxysilyl, methyldimethoxysilyl, triethoxysilyl, and methyldiethoxysilyl groups, from the viewpoint of the reactivity and the availability thereof.

One species, or two or more species, of reactive silicon group may be used in combination in chemical formula (1).

The introduction of the reactive silicon group into a polyoxyalkylene polymer main chain of component (A) is performed by a known method. Examples thereof include the following methods:

(i) A polyoxyalkylene polymer having a functional group such as a hydroxy group is caused to react with an organic compound having an active group exhibiting reactivity with the functional group and having an unsaturated group, thereby yielding a polyoxyalkylene polymer having the unsaturated group. Alternatively, for example, when an epoxide is subjected to ring-opening polymerization to yield a polyoxyalkylene polymer, an unsaturated group-containing epoxide is ring-opening-copolymerized therewith to yield an unsaturated group-containing polyoxyalkylene polymer. In such a way, a monomer having an unsaturated group unrelated to any polymerization reaction is copolymerized, thereby yielding an unsaturated group-containing organic polymer. Next, a hydrosilane having a reactive silicon group is caused to react onto the resulting reaction production, thereby the reaction product is hydrosilylated.

In order to introduce the reactive silicon group at a high introduction ratio in method (i), it is preferred to add a hydrosilane compound to an organic polymer containing an unsaturated group represented by CH₂═C(R⁴)—CH₂— or CH(R⁴)═CH—CH₂—, wherein R⁴ represents hydrogen or a hydrocarbon group having 1 to 10 carbon atoms, thereby attaining the introduction. More preferably, R⁴ is a hydrogen or methyl group. In order to set the introduction ratio of the reactive silicon group to 85% or more, it is particularly important that R⁴ is a methyl group.

Specific examples of the hydrosilane compound used in the method (i) include halogenated silanes such as trichlorosilane, methyldichlorosilane, dimethylchlorosilane, and phenyldichlorosilane; alkoxysilanes such as trimethoxysilane, triethoxysilane, methyldiethoxysilane, methyldimethoxysilane, and phenyldimethoxysilane; acyloxysilanes such as methyldiacetoxysilane and phenyldiacetoxysilane; and ketoximate silanes such as bis(dimethyl ketoximate)methylsilane and bis(cyclohexyl ketoximate)methylsilane. However, the hydrosilane compound is not limited thereto. Out of these compounds, halogenated silanes and alkoxysilanes are particularly preferred, and alkoxysilanes are most preferred, since the hydrolyzability of the composition obtained therefrom is mild so that the composition is easily handled.

(ii) A compound having a mercapto group and a reactive silicon group are caused to react with an unsaturated group-containing polyoxyalkylene polymer obtained in the same manner as in method (i).

The synthesis method (ii) is, for example, a method of introducing a compound having a mercapto group and a reactive silicon group into an unsaturated bond moiety of an organic polymer by radical addition reaction in the presence of a radical initiator and/or a radical-generating source. However, the method is not particularly limited. Specific examples of the compound having a mercapto group and a reactive silicon group include, but are not limited to, γ-mercaptopropyltrimethoxysilane, γ-mercaptopropylmethyldimethoxysilane, γ-mercaptopropyltriethoxysilane, and γ-mercaptopropylmethyldiethoxysilane.

(iii) A polyoxyalkylene polymer having a functional group such as a hydroxyl group, an epoxy group, or an isocyanate group is caused to react with a compound having a functional group having reactivity to the former functional group and having a reactive silicon group. The functional groups of the compound are not limited, but an isocyanate group or amino group is preferable. An isocyanate group is particularly preferable.

Out of individual choices for the synthesis method (iii), the method for causing a polyoxyalkylene polymer having a hydroxyl group at its terminal end to react with a compound having an isocyanate group and a reactive silicon group is, for example, a method described in Japanese Laid-Open Patent Application No. 3-47825. However, the method is not particularly limited. Specific examples of the compound having an isocyanate group and a reactive silicon group include γ-isocyanatopropyl-trimethoxysilane, γ-isocyanatopropyl-methyldimethoxysilane, γ-isocyanatopropyl-triethoxysilane, γ-isocyanatopropyl-methyldiethoxysilane, α-isocyanatomethyl-dimethoxymethylsilane, and α-isocyanatomethyl-trimethoxysilane. However, the compound is not limited thereto.

Out of the above-mentioned methods, method (i) or (iii) is preferred since the polymer obtained by method (ii) emits a strong odor based on the mercaptosilane. In connection with the method for introducing the reactive silicon group, the organic polymer obtained by the method (i), which has the reactive silicon group(s), is more preferred than the polymer obtained by the method (iii) since the polymer becomes a composition having a low viscosity and a good workability. On the other hand, the method (iii) is preferred since the introduction of a silyl group into a hydroxyl group-containing polymer can be attained only in one step so that the Component (A) can be produced with a good productivity.

Out of individual choices for the method (iii), preferred is a method of causing a polyoxyalkylene polymer having a hydroxyl group at its terminal end to react with a compound having an isocyanate group and a reactive silicon group, since a high conversion ratio is obtained in a relatively short reaction time. An oxyalkylene polymer obtained by such a reaction is a polymer having the reactive silicon group(s) and a group represented by the following general formula (3):

—NR³—C(═O)— (3)

wherein R³ represents a hydrogen atom, an alkyl group having 1 to 20 carbon atoms, an aryl group having 6 to 20 carbon atoms, or an aralkyl group having 7 to 20 carbon atoms.

Component (A) having a group represented by the general formula (1) can also be obtained by a method other than the above mentioned methods. Specifically, a compound obtained by a chain-elongating reaction of a polyol with a diisocyanate compound, for example, an aromatic polyisocyanate, such as toluene(tolylene)diisocyanate, diphenylmethanediisocyanate or xylylenediisocyanate, or an aliphatic polyisocyanate, such as isophoronediisocyanate or hexamethylenediisocyanate, is a compound having a group of the general formula (3), regardless of the method for introducing the reactive silicon group.

Component (A) may be linear or branched, and the number-average molecular weight thereof is 500 or more, 3,000 or more, 15, 000 or less, and/or 100,000 or less in terms of polystyrene based on gel permeation chromatography (GPC). The number-average molecular weight is between 1,000 to 50,000, 1,000 to 10,000 or less, 10,000 or more, and 50,000 or less. The molecular weight is measured with the use of HLC-8120GPC (TOSOH CORPORATION) as a solution-sending system, TSK-GEL H type column (TOSOH CORPORATION), and THF solvent.

The reactive silicon group of Component (A) may be bonded to a terminal end of the polyoxyalkylene polymer or along the polymer chain between the terminal ends thereof, or a plurality of the reactive silicon groups may be bonded to both of a terminal end thereof and along the polymer chain between the terminal ends thereof. In particular, when the reactive silicon group is bonded only to the terminal end, the network of the polymer component contained in the composition is effectively constructed. Thus, this case is preferred since a rubbery cured product high in strength and elongation is easily obtained.

As the method for measuring the introduction ratio of the reactive silicon groups in component (A), various methods can be used. The ratio can be calculated from the integral value of the terminal ends to which the reactive silicon groups are introduced on the basis of the 1H-NMR spectrum thereof. The introduction ratio of the reactive silicon groups is a numerical value obtained by representing, in percentage, the value obtained by dividing the number of the reactive silicon groups present in the molecule by the number of the terminal ends of the molecule. Specifically, in the case of a linear polymer (that is, a polymer having two terminal ends), having in a single polymer chain thereof two reactive silicon groups, on average, an introduction ratio of 100% is calculated out. For this reason, with a polymer wherein many reactive silicon groups are present at moieties other than terminal ends of the polymer chain, the calculated value of the introduction ratio may be over 100%. In the present invention, a linear polymer having reactive silicon groups only at both terminal ends can preferably be used. Usually a polymer of introduction ratio of less than 85% is used. A linear polyoxyalkylene polymer having reactive silicon groups only at both terminal ends thereof can be prepared as follows:
(a) Hydroxyl groups that are present only at the terminal ends of a linear polyoxyalkylene polymer is converted to —OM groups (wherein M is Na or K). The resulting polymer is reacted with an organic halogen compound represented by the formula CH₂═C(R⁴)—CH₂—Z (wherein R⁴ is the same as defined above and Z is a halogen atom) to obtain polyoxyalkylene polymer having an unsaturated group(s) only at its terminal ends. A hydrosilane compound represented by the formula H—Si(R¹₃₋ₐ)Xₐ (wherein R¹, X, and a are the same as defined above) is added to react with a polyoxyalkylene polymer having an unsaturated group(s) only at its terminal ends to obtain a linear polyoxyalkylene polymer with reactive silicon groups only at its terminal ends.
(b) A linear polyoxyalkylene polymer having hydroxyl groups only at the terminal ends thereof is reacted with a compound having an isocyanate group and a group represented by the formula —Si(R¹₃₋ₐ)Xₐ (wherein R¹, X, and a are the same as defined above) to obtain a linear polyoxyalkylene polymer with reactive silicon groups only at its terminal ends.

The number of the reactive silicon groups in a single polymer chain of the Component (A) is 0.5 or more on average, 1 or more on average, from 0.8 to 3, or from 1.1 to 5.

Specific examples of the polyoxyalkylene polymer of component (A), which has reactive silicon group(s), are suggested in Japanese Publication of examined patent application (Kokoku) No. 45-36319, Japanese Publication of examined patent application (Kokoku) No. 46-12154, Japanese Laid-Open Patent Application No. 50-156599, Japanese Laid-Open Patent Application No. 54-6096, Japanese Laid-Open Patent Application No. 55-13767, Japanese Laid-Open Patent Application No. 55-13468, Japanese Laid-Open Patent Application No. 57-164123, Japanese Publication of examined patent application (Kokoku) No. 3-2450, U.S. Pat. Nos. 3,632,557, 4,345,053, 4,366,307 and 4,960,844, and others. Other examples thereof are polyoxyalkylene polymers suggested in Japanese Laid-Open Patent Application No. 61-197631, Japanese Laid-Open Patent Application No. 61-215622, Japanese Laid-Open Patent Application No. 61-215623, and Japanese Laid-Open Patent Application No. 61-218632. The polyoxyalkylene polymers are polymers having a number-average molecular weight of 6,000 or more, and a molecular weight distribution (Mw/Mn) of 1.6 or less, and having reactive silicon group(s), which have a high molecular weight and a narrow molecular weight distribution. However, component (A) is not particularly limited thereto.

The above-mentioned polyoxyalkylene polymers, which each have reactive silicon group(s), may be used alone or in combination of two or more thereof.

The organic polymers of component (A) are commercially available and/or can be prepared in accordance with techniques known in the art. Examples of these polymers containing reactive silicon groups include but are not limited to silyl-terminated polyether and silane-terminated polyurethane. More specific examples of commercially available polymers containing reactive silicon groups for component (A) include but are not limited to KANEKA MS POLYMER® S327, KANEKA MS POLYMER® S227, KANEKA MS POLYMER® S203H, KANEKA SILYL® SAX510, KANEKA SILYL® SAX220, KANEKA SILYL® SAT145, KANEKA SILYL® SAT115, and combinations thereof.

The above exemplary list of commercially available polymers is by no means an exhaustive list and other polymers having reactive silicon groups can be utilized. Further, in some embodiments, it may be beneficial to combine different polymers. For example, in some embodiments, there can be a need to balance a high viscosity grade polymer, which is used to lower the modulus for adhesion with a low viscosity grade polymer to allow easy application via brush, trowel, squeegee, spray gun, or other application techniques known in the art. In some embodiments, the organic polymer of component (A) can include a combination of different polymers. For example, one polymer may have a high viscosity and another polymer may have a low viscosity. In some embodiments, the high viscosity may be greater than 20,000 cP at 23° C. In some embodiments, the low viscosity may be lower than 5,000 cP at 23° C. In some embodiments, the low viscosity may range from 6,000 to 10,000 cP at 23° C. When utilized, the high viscosity grade polymer and the low viscosity grade polymer can be present in a weight ratio of 90:10 to 10:90, preferably 75:25 to 25:75 (high: low viscosity, respectively), based on the total weight of component (A).

Component (A) can be included in the moisture curable adhesive composition in amounts ranging from about 5 wt % to about 60 wt %, based on the total weight of the moisture curable adhesive composition. More preferably, the amounts may range from about 10 wt % to about 50 wt %. Most preferably, the amounts may range from about 15 to about 40 wt %.

### Component (B)

The curable composition comprises a component (B) having a chlorinated polyolefin polymer (CPO). Component (B) may be utilized as an adhesion promoter in the curable composition. The CPO of component (B) used in the present invention is not particularly limited, and may be known in the art. Specific examples thereof include chlorinated polyethylene and chlorinated polypropylene, copolymers thereof, and the chlorinated polyolefins modified with acrylic acid moieties, maleic acid, and/or maleic anhydride. Specific examples of chlorinated polyolefin polymers include but are not limited to AdvaBond® 8203, AdvaBond® 8232, AdvaBond® 8214, and combinations thereof.

Component (B) can be included in the moisture curable adhesive composition in amounts ranging from about 1 wt % to about 15 wt %, based on the total weight of the moisture curable adhesive composition. More preferably, the amounts may range from about 2 wt % to about 10 wt %. Most preferably, the amounts may range from about 3 wt % to about 8 wt %.

### Component (C)

The curable composition comprises a component (C) having a silane compound having a dimethoxysilyl moiety. The silane compound having a dimethoxysilyl moiety can be represented by chemical formula 1:

R₁(R₂)Si(OCH₃)₂ [chemical formula 1]

R₁ is a substituent that includes one or more amino groups. The one or more amino groups include —NH₂ and —NH—. In some embodiments, R₁ can be —CH₂CH₂CH₂N(H)CH₂CH₂NH₂ or —CH₂CH₂CH₂NH₂. R₂ is an alkyl group. In one embodiment, R₂ is —CH₃.

In one embodiment, the silane compound having a DMS moiety is represented by the following chemical formula 1-1:

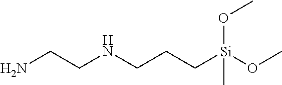

The silane compound of component (C) is not particularly limited, and may be known in the art. Specific examples of the first silane include but are not limited to Dynasylan® 1401 or 1411, available from Evonik Industries; Geniosil® GF 95, available from Wacker Chemie; Z-6023, available from Dow Silicones Corporation; Silquest™ A-2120, available from Momentive Performance Materials; and KBM602, available from Shin-Etsu Chemical Company. Moreover, though described above as an aminosilane, the silane compound of component (C) is not limited thereto. Other silane compounds, such as copolymer oligomers, alkylsilanes, glycidylsilanes, isocyanatosilanes, thiocyanatosilanes, methacrylsilanes, ureidosilanes, and mercaptosilanes, are possible.

Component (C) can be included in the moisture curable adhesive composition in amounts ranging from about 0.1 wt % to about 5.0 wt %, based on the total weight of the moisture curable adhesive composition. More preferably, the amounts may range from about 0.2 wt % to about 3.0 wt %. Most preferably, the amounts may range from about 0.3 wt % to about 2.0 wt %.

### Component (D)

The curable composition comprises a component (D) having a silane compound having a trimethoxysilyl (TMS) moiety. The first silane is represented by chemical formula 2:

R₁Si(OCH₃)₃ [chemical formula 2]

R₁ is a substituent that includes one or more amino groups. The one or more amino groups include —NH₂ and —NH—. In one embodiment, R₁ is —CH₂CH₂CH₂N(H)CH₂CH₂NH₂. In another embodiment, R₁ is CH₂CH₂CH₂N(H) CH₂CH₂CH₂Si(OCH₃)₃. In yet another embodiment, R₁ is CH₂CH₂CH₂NH₂.

In one embodiment, the silane compound having a TMS moiety is represented by the following chemical formula 2-1:

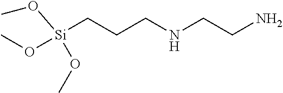

The silane compound of component (D) is not particularly limited, and may be known in the art. Specific examples of the second silane include but are not limited to Dynasylan® DAMO-T or DAMO or AMMO or 1124, available from Evonik Industries; Silquest™M A-1120, available from Momentive Performance Materials; Z-6020 or Z-6094, available from Dow Silicones Corporation; Geniosil® GF 91, available from Wacker Chemie; and KBM603, available from Shin-Etsu Chemical Company. Moreover, though described above as an aminosilane, the silane compound of component (D) is not limited thereto. Other silane compounds, such as copolymer oligomers, alkylsilanes, glycidylsilanes, isocyanatosilanes, thiocyanatosilanes, methacrylsilanes, ureidosilanes, and mercaptosilanes, are possible.

Component (D) can be included the moisture curable adhesive composition in amounts ranging from about 0.1 wt % to about 5.0 wt %, based on the total weight of the moisture curable adhesive composition. More preferably, the amounts may range from about 0.2 wt % to about 3.0 wt %. Most preferably, the amounts may range from about 0.3 wt % to about 2.0 wt %.

The moisture curable adhesive composition of the present invention may optionally contain various other additives such as fillers, pigments, dehydration agents, plasticizers, anti-sagging agents (thixotropic agents), stabilizers, other adhesion promoters, and curing catalysts.

In some embodiments, the moisture curable adhesive composition may contain various fillers. Examples of the fillers include reinforcing fillers such as fumed silica, precipitated silica, crystalline silica, and carbon black; fillers such as heavy calcium carbonate, colloidal calcium carbonate, magnesium carbonate, diatomite, calcined clay, clay, talc, titanium oxide, and bentonite; and fibrous fillers such as glass fibers and filaments. Exemplary fillers include Hubercarb®Q3T, which is a calcium carbonate, available from Huber Engineered Materials of Atlanta, Georgia, USA; and Hubercarb®G8, which is a calcium carbonate, available from Huber Engineered Materials.

In some embodiments, the moisture curable adhesive composition may include a dehydration agent to improve the storage stability. A dehydration agent may be, but need not be, limited to an alkoxysilane compound such as n-propyl trimethoxy silane, octyl trimethoxy silane, or vinyl trimethoxy silane. Exemplary dehydration agents can include VTMO, which is a vinyl trimethoxy silane dehydration agent, available from Evonik Industries; and OCTMO, which is an octyl trimethoxy silane dehydration agent, available from Evonik Industries.

In some embodiments, the moisture curable adhesive composition further includes one or more catalysts. Examples of the additional catalyst include amine compounds such as aliphatic primary amines, aliphatic secondary amines, aliphatic tertiary amines, and aliphatic unsaturated amines; nitrogen-containing heterocyclic compounds such as pyridine, imidazole, and amidines such as 1,8-diazabicyclo (5,4,0) undecene-7 (DBU). Exemplary additional catalysts may include Polycat DBU, which is a diazobicycloundecene, available from Evonik Industries; Dyhard OTB, which is 1-(o-Tolyl) biguanide, available from AlzChem Group; Neostann U220H, which is dibutyltin diacetylacetonate, available from Nitto Kasei Co., Ltd; and Fomrez® SUL-11C, which is a dibutyltin oxide, available from Galata Chemicals.

In some embodiments, the moisture curable adhesive composition may include an antioxidant. The antioxidant is preferably a hindered phenolic antioxidant. Examples of the hindered phenolic antioxidant include but are not limited to Irganox® 245, Irganox® 1010, and Irganox® 1076, available from BASF, and combinations thereof.

In some embodiments, the moisture curable adhesive composition may include a light stabilizer. The light stabilizer can prevent photo-oxidative degradation of the cured product. Examples of the light stabilizer include but are not limited to benzotriazole compounds, hindered amine compounds, and benzoate compounds.

In some embodiments, the adhesive composition may include an ultraviolet absorber. The ultraviolet absorber can increase the surface weather resistance of the cured product. Examples of the ultraviolet absorber include but are not limited to benzophenone compounds, benzotriazole compounds, salicylate compounds, substituted tolyl compounds, and metal chelate compounds.

In some embodiments, the moisture curable adhesive composition may include thixotropic agent. Specific examples of thixotropic agent include but are not limited to hydrogenated castor oil, organic amide wax, organic bentonite, and calcium stearate. These thixotropic agents may be used alone or in combination of two or more thereof.

In some embodiments, the moisture curable adhesive composition may include plasticizer to control the viscosity. Specific examples of plasticizers include but are not limited to phthalate compounds such as dibutyl phthalate, diisononyl phthalate, di(2-ethylhexyl) phthalate, and diisodecyl phthalate; non-phthalate compounds such as 1, 2-cyclohexane dicarboxylic acid diisononyl ester; aliphatic polycarboxylate compounds; unsaturated fatty acid ester compounds, alkyl sulfonic acid phenyl esters, hydrocarbon oils and polymeric plasticizer such as polyether polyols and glycol ether esters. These plasticizers may be used alone or in combination of two or more thereof. An exemplary plasticizer is POLY-G®20-37, which is a polypropylene glycol having a number average molecular weight (Mn) of 3,000 g/mol, available from Monument Chemical of Indianapolis, Indiana, USA.

Various other additives may optionally be added to the moisture curable adhesive composition of the present invention in order to control the properties of the curable composition or cured product. Examples of such additives include flame retardants, curability modifiers, lubricants, pigments, and antifungal agents. These additives may be used alone or in combinations of two or more.

### EXAMPLES

The curable composition of the invention will be described on the basis of the following examples; however, the invention is not limited to these examples.

### Comparative Examples 1 to 5 and Inventive Examples 1 to 3

All components were weighed according to the formulations shown in Table 1, and then mixed and kneaded by a mixer under dehydration conditions with substantially no water. In Table 1, component (C) is a silane compound having a DMS moiety represented by chemical formula 1-1 and component (D) is a silane compound having a TMS moiety represented by chemical formula 2-1. Thereafter the mixture was packed into moisture-proof containers (polyethylene cartridge). The curable compositions of Examples 1 to 3 and Comparative Examples 1 to 5 were produced in this way. Unless otherwise noted, each composition was measured after initial formation at 23° C. and then again at 23° C. after storage for 4 hours, 24 hours, and 13 days. The properties of the resultant curable compositions were measured as follows:

Viscosity: A RV type Brookfield viscometer was used to measure the viscosity of each composition (Spindle: No. 6, 1 rpm, 2 rpm, 10 rpm, and 20 rpm, temperature: 23° C.).

Peel: The specimens with size 1.0 inch×6.0 inch were cut from TPO single-ply roof membrane. Each of the compositions was applied on a rigid substrate, such as DensDeck Prime, plywood, or concrete, to form a uniform layer, then a TPO specimen was pressed on top of the adhesive layer. Two testing specimens were prepared for each formulation. The test specimens were allowed to cure at 23° C. and 50% R.H. for the given curing period shown in Table 2. After the curing period, the adhesion strength was measured using Shimadzu tensile tester Model AGS-20KNXD with peeling rate 2 inch/min and average peel strength was recorded. The rigid substrate including the mounted TPO specimen is secured to a movable stage that is moveable in a direction perpendicular to the movement of a tester clamp. The TPO specimen is bent upward and secured in the tester clamp, such that an approximately 90 degree peel angle is formed. As the tester peels the TPO specimen, the stage moves freely to maintain an approximately 90 degree peel angle throughout the test. The experimental setup is similar to ASTM D6862, except the freely moving stage allows for more stiff but still flexible substrates like TPO membranes to be arranged and peeled at 90 degree angles with better consistency. In contrast, a moving stage, such as in ASTM D6862, requires alignment which can be more difficult for the larger bending radius of stiff membranes versus thin tapes. Thus, it is difficult to get consistent peel strength results for these materials using ASTM D6862. A Peel strength at 4 hours of less than 1 pli is poor, 1-2 pli is good, and higher than 2 pli is excellent. At 24 hours and longer, peel strength lower than 4 pounds per linear inch (“pli”) is considered poor. Peel strength of between 4-5 pli is considered adequate. Peel strength of between 5-6 pli is considered good, and peel strength higher than 6 pli is considered as excellent.

As shown in Table 2, the use of a combination of components (C) and (D) as adhesion promoters has advantages for adhesion after a short period of time. Examples 1 to 3 using both components (C) and (D) has superior adhesion after 4 hours and 24 hours, respectively. Comparative Examples 1 to 5, using either component (C) or component (D) has negligible adhesion after 4 hours. Comparative Example 5 demonstrated comparable adhesion to Examples 1 to 3 at 24 hours and 13 days. However, comparative example 5 has limited utility due to significantly higher viscosity than the Examples. Comparative Examples 1 to 4 were not equivalent to the adhesion strength of Examples 1 to 3 at 24 hours, even when measured after 13 days.

TABLE 1
Adhesive Formulations of Examples and Comparative Examples

| | | | | | Comp | Comp | Comp | Comp | Comp |
|---|---|---|---|---|---|---|---|---|---|
| | | Ex 1 | Ex 2 | Ex 3 | Ex 1 | Ex 2 | Ex 3 | Exe 4 | Ex 5 |
| | | PHR | PHR | PHR | PHR | PHR | PHR | PHR | PHR |
| Component (A) | silyl terminated polyether | 100 | 100 | 100 | 100 | 100 | 100 | 100 | 100 |
| Plasticizer | PPG 3000 | 90 | 90 | 90 | 90 | 90 | 90 | 90 | 90 |
| Calcium Carbonate | calcium carbonate | 280 | 280 | 280 | 280 | 280 | 280 | 280 | 280 |
| Thermal Stabilizer | antioxidant | 2 | 2 | 2 | 2 | 2 | 2 | 2 | 2 |
| Dehydration Agent | vinyl trimethoxy silane | 4 | 4 | 4 | 4 | 4 | 4 | 5 | 5 |
| Component (B) | chlorinated polyolefin | 28 | 28 | 28 | 28 | 28 | 28 | 28 | 28 |
| | polymer | | | | | | | | |
| Component (C) | silane compound with | 2 | 2 | 2 | | | | | 5 |
| | DMS moiety | | | | | | | | |
| Component (D) | silane compound with | 3 | 3 | 3 | 5 | 5 | 5 | 5 | |
| | TMS moiety | | | | | | | | |
| Catalyst | 1-(o-tolyl)biguanide | 5 | 5 | 5 | 5 | 5 | 5 | 5 | 5 |
| Catalyst | dibutyltin oxide | 3 | 3 | 3 | 3 | 3 | 3 | 2 | 2 |
| | Total | 517 | 517 | 517 | 517 | 517 | 517 | 517 | 517 |

TABLE 2
Properties of Examples and Comparative Examples

| | | | | Cure in | | | |
|---|---|---|---|---|---|---|---|
| | | | | depth | Peel (PLI) | | |
| | Viscosity (cP) | | Skin | (after | | | 13 |
| | Speed | | Time | 1 day) | 4 hr | 24 hr | day |
| | (rpm) | Initial | (min) | (mm) | TPO | TPO | TPO |
| Example 1 | 1 | 60,000 | 86 | 3.64 | 2.96 | 6.76 | 9.85 |
| | 2 | 47,500 | | | | | |
| | 10 | 32,100 | | | | | |
| | 20 | 28,450 | | | | | |
| Example 2 | 1 | 55,000 | 82 | 4.06 | 2.52 | 7.57 | 9.10 |
| | 2 | 44,000 | | | | | |
| | 10 | 29,500 | | | | | |
| | 20 | 26,150 | | | | | |
| Example 3 | 1 | 66,000 | 79 | 3.68 | 2.28 | 7.54 | 9.52 |
| | 2 | 52,000 | | | | | |
| | 10 | 35,100 | | | | | |
| | 20 | 31,200 | | | | | |
| Comparative | 1 | 59,000 | 61 | 3.16 | 0.81 | 0.62 | 2.78 |
| Example 1 | 2 | 50,500 | | | | | |
| | 10 | 38,600 | | | | | |
| | 20 | 35,600 | | | | | |
| Comparative | 1 | 57,000 | 60 | 3.2 | 0.59 | 0.67 | 4.39 |
| Example 2 | 2 | 46,500 | | | | | |
| | 10 | 32,900 | | | | | |
| | 20 | 30,050 | | | | | |
| Comparative | 1 | 65,000 | 60 | 3.16 | 0.56 | 0.75 | 4.23 |
| Example 3 | 2 | 54,000 | | | | | |
| | 10 | 39,900 | | | | | |
| | 20 | 36,750 | | | | | |
| Comparative | 1 | 61,000 | 179 | 2.69 | 0.5 | 2.86 | 6.88 |
| Example 4 | 2 | 45,000 | | | | | |
| | 10 | 27,900 | | | | | |
| | 20 | 25,450 | | | | | |
| Comparative | 1 | 224,000 | 150 | 3.04 | 0.76 | 6.47 | 9.81 |
| Example 5 | 2 | 196,000 | | | | | |
| | 10 | 138,000 | | | | | |
| | 20 | 122,600 | | | | | |

To summarize, the present disclosure discloses a curable composition, comprising a component (A) having an organic polymer containing reactive silicon groups; a component (B) having a chlorinated polyolefin polymer; a component (C) having a silane compound having a dimethoxysilyl moiety; and a component (D) having a silane compound having a trimethoxysilyl moiety; and/or
the reactive silicon groups are represented by the following general formula (1):

—Si(R¹₃₋ₐ)Xₐ (1)
wherein R¹ represents an alkyl group having 1 to 20 carbon atoms, an aryl group having 6 to 20 carbon atoms, or an aralkyl group having 7 to 20 carbon atoms; wherein X represents a hydrolyzable group; wherein each X is the same or different when two or more X are present; a is an integer from 1 to 3; when a is 1, each R¹ may be the same or different, and when a is 2 or 3, each X may be the same or different; and/or
the hydrolyzable group is selected from the group consisting of a hydroxy group, a halogen, an alkoxy group, an acyloxy group, a ketoximate group, an amino group, an amide group, an acid amide group, an aminooxy group, a mercapto group, and an alkenyloxy group; and/or
the hydrolyzable group is an alkoxy group, and selected from the group consisting of a methoxy group, an ethoxy group, a propoxy group, and an isopropoxy group; and/or
the organic polymer comprises a main chain of polyoxypropylene; and/or
the organic polymer comprises a group represented by the following general formula (3):

—NR³C(═O)— (3)
wherein R³ represents a hydrogen atom, an alkyl group having 1 to 20 carbon atoms, an aryl group having 6 to 20 carbon atoms, or an aralkyl group having 7 to 20 carbon atoms; and/or
further comprising an additive; and/or
the additive is selected from the group consisting of a filler, a dehydration agent, a plasticizer, a stabilizer, a catalyst, and combinations thereof; and/or
the silane compound having the dimethoxysilyl moiety is represented by chemical formula 1:

R₁(R₂)Si(OCH₃)₂ [chemical formula 1]
wherein R₁ is a substituent that includes one or more amino groups, wherein the one or more amino groups are independently selected from the consisting of —NH₂ and —NH—, and wherein R₂ is an alkyl group; and/or
the silane compound having the dimethoxysilyl moiety is represented by chemical formula 1-1:

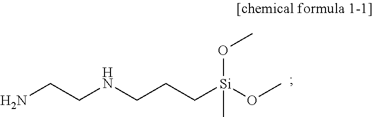

and/or
the silane compound having the trimethoxysilyl moiety is represented by chemical formula 2:

R₁Si(OCH₃)₃ [chemical formula 2]
wherein R₁ is a substituent that includes one or more amino groups, where the one or more amino groups are independently selected from the group consisting of —NH₂ and —NH— and/or
the silane compound having the trimethoxysilyl moiety is represented by chemical formula 2-1:

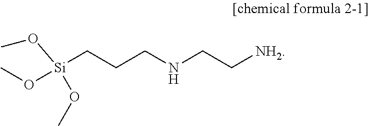

The present disclosure also discloses a method of applying the curable composition, comprising applying the curable composition of claim 1 to a substrate; and/or
the substrate is selected from the group consisting of polyvinyl chloride (PVC), ethylene propylene diene rubber (EPDM), and thermoplastic polyolefin (TPO); and/or
   the substrate is thermoplastic polyolefin (TPO); and/or
   the substrate is a smooth-backed substrate.

The present disclosure also discloses a composition, comprising a substrate; and the curable composition; and/or
the substrate is selected from the group consisting of polyvinyl chloride (PVC), ethylene propylene diene rubber (EPDM), and thermoplastic polyolefin (TPO); and/or
the substrate is thermoplastic polyolefin (TPO); and/or
the substrate is a smooth-back substrate.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A curable composition, comprising:
a component (A) having an organic polymer containing reactive silicon groups;
a component (B) having a chlorinated polyolefin polymer;
a component (C) having a silane compound having a dimethoxysilyl moiety; and
a component (D) having a silane compound having a trimethoxysilyl moiety.

2. The curable composition of claim 1, where the reactive silicon groups are represented by the following general formula (1):
—Si(R¹₃₋ₐ)Xₐ (1)
wherein R¹ represents an alkyl group having 1 to 20 carbon atoms, an aryl group having 6 to 20 carbon atoms, or an aralkyl group having 7 to 20 carbon atoms;
wherein X represents a hydrolyzable group, wherein each X is the same or different when two or more X are present;
a is an integer from 1 to 3;
when a is 1, each R¹ may be the same or different; and
when a is 2 or 3, each X may be the same or different.

3. The curable composition of claim 2, wherein the hydrolyzable group is selected from the group consisting of a hydroxy group, a halogen, an alkoxy group, an acyloxy group, a ketoximate group, an amino group, an amide group, an acid amide group, an aminooxy group, a mercapto group, and an alkenyloxy group.

4. The curable composition of claim 2, wherein the hydrolyzable group is an alkoxy group, and is further selected from the group consisting of a methoxy group, an ethoxy group, a propoxy group, and an isopropoxy group.

5. The curable composition of claim 1, wherein the organic polymer comprises a main chain of polyoxypropylene.

6. The curable composition of claim 1, wherein the organic polymer comprises a group represented by the following general formula (3):
13 NR³C(═O) (3)
wherein R³ represents a hydrogen atom, an alkyl group having 1 to 20 carbon atoms, an aryl group having 6 to 20 carbon atoms, or an aralkyl group having 7 to 20 carbon atoms.

7. The curable composition of claim 1, further comprising:
an additive.

8. The curable composition of claim 1, wherein the additive is selected from the group consisting of a filler, a dehydration agent, a plasticizer, a stabilizer, a catalyst, and combinations thereof.

9. The curable composition of claim 1, wherein the silane compound having the dimethoxysilyl moiety is represented by chemical formula 1:
R₁(R₂)Si(OCH₃)₂ [chemical formula 1]
wherein R₁ is a substituent that includes one or more amino groups, wherein the one or more amino groups are independently selected from the consisting of —NH₂ and —NH—, and wherein R₂ is an alkyl group.

10. The curable composition of claim 9, wherein the silane compound having the dimethoxysilyl moiety is represented by chemical formula 1-1:

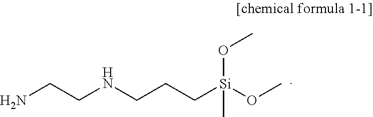

11. The curable composition of claim 1, wherein the silane compound having the trimethoxysilyl moiety is represented by chemical formula 2:
R₁Si(OCH₃)₃ [chemical formula 2]
wherein R₁ is a substituent that includes one or more amino groups, where the one or more amino groups are independently selected from the group consisting of —NH₂ and —NH—.

12. The curable composition of claim 1, wherein the silane compound having the trimethoxysilyl moiety is represented by chemical formula 2-1:

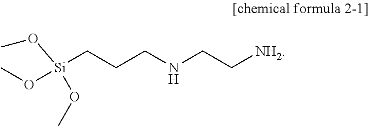

13. A method of applying a curable composition, comprising:
applying the curable composition of claim 1 to a substrate.

14. The method of claim 13, wherein the substrate is selected from the group consisting of polyvinyl chloride (PVC), ethylene propylene diene rubber (EPDM), and thermoplastic polyolefin (TPO).

15. The method of claim 13, wherein the substrate is thermoplastic polyolefin (TPO).

16. The method of claim 13, wherein the substrate is a smooth-backed substrate.

17. A composition, comprising:
a substrate; and
the curable composition of claim 1.

18. The composition of claim 17, wherein the substrate is selected from the group consisting of polyvinyl chloride (PVC), ethylene propylene diene rubber (EPDM), and thermoplastic polyolefin (TPO).

19. The composition of claim 17, wherein the substrate is thermoplastic polyolefin (TPO).

20. The composition of claim 17, wherein the substrate is a smooth-backed substrate.
